(19) United States
(12) Patent Application Publication
(10) Pub. No.: US 2017/0153581 A1
(43) Pub. Date: Jun. 1, 2017

(54) IMAGE HEATING APPARATUS

(71) Applicant: CANON KABUSHIKI KAISHA, Tokyo (JP)

(72) Inventor: Youichi Chikugo, Abiko-shi (JP)

(21) Appl. No.: 15/353,972

(22) Filed: Nov. 17, 2016

(30) Foreign Application Priority Data
Dec. 1, 2015 (JP) 2015-234634

(51) Int. Cl. G03G 15/20

(52) U.S. Cl. CPC G03G 15/20

(57) ABSTRACT

An image heating apparatus includes rotatable members; a roller; a detector; a displacing mechanism configured to displace one longitudinal end of the roller from a first position to a second position depending on an output of the detector so as to return the endless belt to the predetermined zone; and a timer configured to count a time in which the endless belt is out of the predetermined zone from displacement of the roller to the second position by the displacing mechanism. When the time counted by the timer is a predetermined time, the displacing mechanism displaces the one longitudinal end of the roller to a third position remoter from the first position than the second position so as to return the endless belt is returned to the predetermined zone.

### FIELD OF THE INVENTION AND RELATED ART

The present invention relates to an image heating apparatus for heating a toner image on a recording material. The image heating apparatus is usable in, e.g., an image forming apparatus such as a copying machine, a printer, a facsimile machine or a multi-function machine having a plurality of functions of these machines.

Japanese Laid-Open Patent Application (JP-A) Hei 5-238614 discloses a fixing device using an endless belt. In such an endless belt using the endless belt, a countermeasure against a phenomenon that the endless belt shifts in a widthwise direction thereof is required.

Therefore, in the device described in JP-A Hei 5-238614, a constitution in which a roller for stretching the endless belt is inclined relative to another roller and thus the endless belt is swung positively in a predetermined zone is employed.

Specifically, in the device described in JP-A Hei 5-238614, a constitution in which a position of the endless belt with respect to a widthwise direction of the endless belt is detected at a plurality of levels is employed. More specifically, the position of the endless belt is detected using a plurality of sensors provided so that their positions are shifted from each other. Then, depending on the position of the endless belt, an inclination angle of the roller is controlled.

However, in such a constitution, a plurality of sensors are required, so that there is room for improvement.

### SUMMARY OF THE INVENTION

According to an aspect of the present invention, there is provided an image heating apparatus comprising: a pair of rotatable members at least one of which is an endless belt and configured to form a nip for heating a toner image on a recording material; a roller configured to rotatably support the endless belt; a detector configured to detect that the endless belt is out of a predetermined zone with respect to a widthwise direction thereof; a displacing mechanism configured to displace one longitudinal end of the roller from a first position to a second position depending on an output of the detector so as to return the endless belt to the predetermined zone; and a timer configured to count a time in which the endless belt is out of the predetermined zone from displacement of the roller to the second position by the displacing mechanism, wherein when the time counted by the timer is a predetermined time, the displacing mechanism displaces the one longitudinal end of the roller to a third position remoter from the first position than the second position so as to return the endless belt to the predetermined zone.

Further features of the present invention will become apparent from the following description of exemplary embodiments with reference to the attached drawings.

### BRIEF DESCRIPTION OF THE DRAWINGS

FIG. 1 (FIG. 1A, FIG. 1B) is a flowchart of belt reciprocating control in a fixing device according to an embodiment.

FIG. 2 is a schematic illustration of an image forming apparatus according to the embodiment.

FIG. 3 is a left-side schematic illustration of the fixing device.

FIG. 4 is a cross-sectional illustration of the fixing device.

FIG. 5 is an illustration of a sensor portion (belt position detecting means) in a pressing belt unit side.

FIG. 6 is an illustration of a belt shift control mechanism in the pressing belt unit side.

FIG. 7 is an illustration of a steering operation for the belt reciprocating control.

FIG. 8 is an illustration of belt position detection.

FIG. 9 is a block diagram of a belt reciprocating control system.

FIG. 10 is a schematic illustration of a belt position in the belt reciprocating control.

FIG. 11 is a timing chart of the belt reciprocating control.

FIG. 12 is another timing chart of the belt reciprocating control.

FIG. 13 is a graph for illustrating an effect of the belt reciprocating control.

### DESCRIPTION OF THE EMBODIMENTS

### Embodiment 1

### (Image Forming Apparatus)

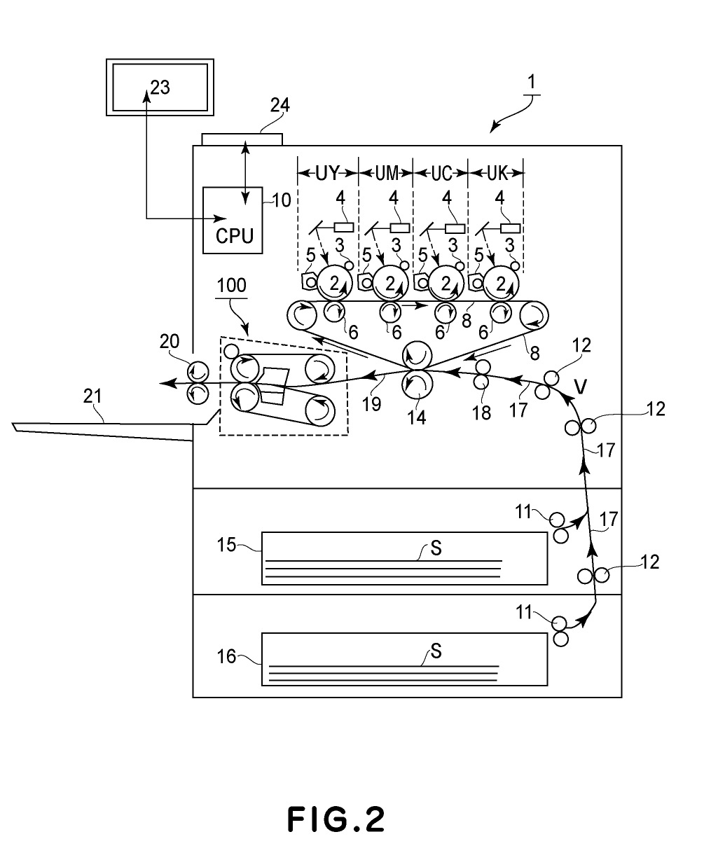

FIG. 2 is a schematic illustration of an example of an image forming apparatus 1. The image forming apparatus 1 includes four image forming portions U (UY, UM, UC, UK) for yellow (Y), magenta (M), cyan (C), black (K). At each of the image forming portions U, a photosensitive drum (image bearing member) 2 electrically charged by a charging roller 3 is exposed to laser light from a laser scanner 4 depending on image information inputted from an external host device 23 into a controller (hereinafter referred to as CPU) 10, so that an electrostatic latent image is formed thereon.

The formed electrostatic latent image is developed as a toner image of an associated one of the colors with toner of the associated color by a developing device 5. The formed toner images of the respective colors are superposedly transferred onto an intermediary transfer belt 8 by primary transfer rollers 6, so that a full-color toner image is formed.

On the other hand, a recording material (hereinafter referred to as a sheet) S accommodated in a cassette 15 or 16 is fed along a feeding path 17 by a feeding roller pair 11, a conveying roller pair 12 and a registration roller pair 18, and is fed to a secondary transfer nip which is a press-contact portion between the intermediary transfer belt 8 and a secondary transfer roller 14. Onto the sheet S fed to the secondary transfer nip, the full-color toner image is secondary-transferred, and the sheet S is passes through a feeding path 19 and is fed to a fixing device 100. The sheet S is heated and pressed by the fixing device 100, and the toner image is fixed on the sheet S, and then the sheet S is discharged onto a discharge tray 21 by a discharging roller 20.

The CPU 10 manages all of device contact operations of the image forming apparatus. An operating portion 24 for permitting input of various pieces of information into the CPU 10 includes a display portion where the various pieces of information are displayed.

### (Fixing Device)

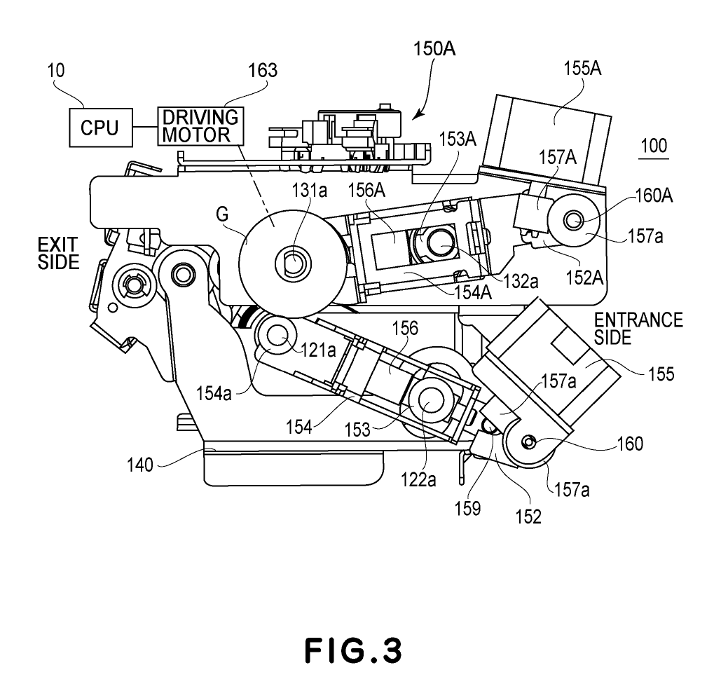

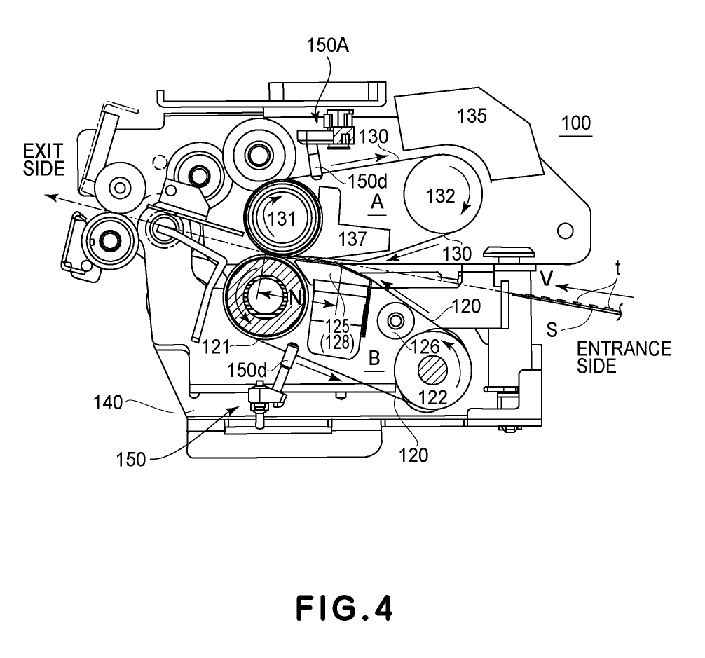

FIG. 3 is a left-side illustration of the fixing device 100, and FIG. 4 is a cross-sectional illustration of the fixing device 100. Here, in this embodiment, a front surface (side) of the fixing device 100 is a surface in a sheet entrance side, and a rear surface (side) of the fixing device 100 is a surface in a sheet exit side. Left and right are those when the fixing device 100 is seen from the front surface, and a left(-hand) side is the front side or one end (portion) side and a right(-hand) side is the rear side or the other end (portion) side. Upper and lower are those with respect to a direction of gravitation. Upstream and downstream are those with respect to a feeding direction (recording material feeding direction) V of the sheet S.

The fixing device 100 is an image heating apparatus of a twin-belt nip type and an electromagnetic induction heating (IH) type. The fixing device 100 roughly includes a heating belt unit A, a pressing belt unit B, an IH heater (heating device, induction heating coil) 135 and a casing 140 accommodating these members.

The heating belt unit A includes an endless heating belt (endless belt) 130 as a first rotatable member. Further, the heating belt unit A includes a plurality of supporting rollers (supporting members), for rotatably supporting (stretching) the heating belt 130 from an inner surface side thereof, including a driving roller 131 and a tension roller 132 for imparting belt tension. Further, the heating belt unit A includes a pad stay 137 formed of, e.g., stainless steel (SUS material).

The IH heater 135 is a dielectric heating means (induction heating means) as a heating means for heating the heating belt 130 and includes an induction heating coil (exciting coil) for heating the heating belt 130 through electromagnetic induction heating.

The heating belt 130 may appropriately selected from those which generate heat by the IH heater 135 and which have a heat resistant property.

For example, a belt prepared by coating, e.g., a 300 μm-thick silicone rubber on a magnetic metal layer of a nickel (metal) layer or a stainless steel layer with a thickness of 75 μm, a width of 380 mm and a peripheral length of 200 mm and then by coating a PFA tube as a surface layer.

The driving roller 131 is, for example, a roller formed by integrally molding a core metal surface layer formed with a solid stainless steel having an outer diameter of 18 mm with a heat-resistant silicone rubber elastic layer. The tension roller 132 is, for example, a hollow roller formed of stainless steel having an outer diameter of 20 mm and an inner diameter of about 18 mm.

The tension roller 132 and the driving roller 131 are disposed in substantially parallel to each other with a predetermined interval in an upstream side and a downstream side with respect to the sheet feeding direction V. The pad stay 137 is disposed between the tension roller 132 and the driving roller 131 in proximity and parallel to the driving roller 131. The heating belt 130 is extended around the driving roller 131, the tension roller 132 and the pad stay 137 with a predetermined tension (e.g., 200 N).

The pressing belt unit B includes an endless pressing belt (endless belt) 120 as a second rotatable member. Further, the pressing belt unit B includes a plurality of supporting rollers (supporting members), for rotatably supporting (stretching) the pressing belt 120 from an inner surface side thereof, including a pressing roller 121 and a tension roller 122 for imparting belt tension. Further, the pressing belt unit B includes a pressing pad 125 formed of, e.g., a rubber. The pressing pad 125 is covered with a slidable sheet 128. Further, the pressing belt unit B includes an oil applying roller (lubricant applying member) 126.

The pressing belt 120 may appropriately be selected from those which resistant property. For example, a belt prepared by coating, e.g., a 300 pm-thick silicone rubber on a magnetic metal layer of a nickel (metal) layer with a thickness of 50 μm, a width of 380 mm and a peripheral length of 200 mm and then by coating a PFA tube as a surface layer. The pressing roller 121 is, for example, a roller formed by integrally molding a core metal surface layer formed with a solid stainless steel having an outer diameter of 20 mm. The tension roller 122 is, for example, a hollow roller formed of stainless steel having an outer diameter of 20 mm and an inner diameter of about 18 mm.

The tension roller 122 and the pressing roller 121 are disposed in substantially parallel to each other with a predetermined interval in an upstream side and a downstream side with respect to the sheet feeding direction V. The pressing pad 125 is disposed between the tension roller 122 and the pressing roller 121 in proximity and parallel to the pressing roller 121. The oil applying roller 126 is disposed in parallel to the tension roller 122 between the pressing pad 125 and the tension roller 122. The pressing belt 120 is extended around the pressing roller 121, the tension roller 122, the pressing pad 125 and the oil applying roller 126 with a predetermined tension (e.g., 200 N).

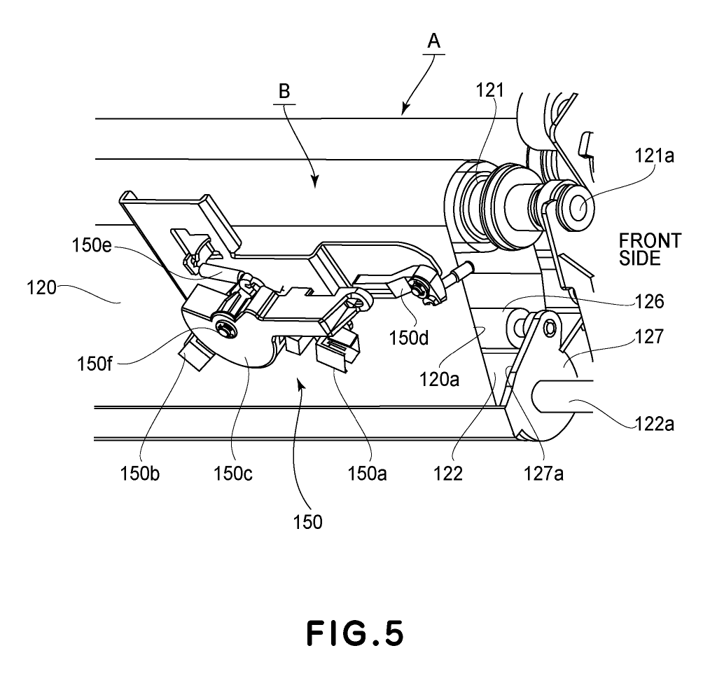

The oil applying roller 126 is, as shown in FIG. 5, supported rotatably by an arm 127 supported rotatably about a shaft 122a of the tension roller 122. Further, the arm 127 is rotationally urged by an urging member (not shown) in a direction in which the oil applying roller 126 operations an inner surface of the pressing belt 120.

The oil applying roller 126 includes a heat-resistant an aramid felt impregnated with, as a lubricant, a heat-resistant silicone oil of about 1000 CS in viscosity and is constituted so that an oil in a certain amount is supplied (applied) onto the inner surface of the pressing belt 120. As a result, a frictional force between the inner surface of the pressing belt 120 and the slidable sheet 128 covering the pressing pad 125 is reduced, so that durability is improved. The heat-resistant silicone oil supplied to the inner surface of the pressing belt 120 is also applied onto the surfaces of the pressing roller 121 and the tension roller 122 via the inner surface of the pressing belt 120.

The pressing belt unit B is disposed below the heating belt unit A. Further, the pressing belt unit B is pressed with a predetermined pressing force against the heating unit A by a pressing operation of a pressing mechanism omitted have from description.

In this pressing state, the heating belt 130 contacting the driving roller 131 and the pressing belt 20 contacting the pressing roller 121 are press-contacted to each other with the predetermined pressing force. The elastic layer of the driving roller 131 is elastically distorted in a predetermined amount by the press-contact between the belts toward the driving roller 121. Further, the heating belt 130 contacting the pad stay 137 and the pressing belt 120 contacting the pressing pad 125 are press-contacted to each other with a predetermined pressing force (e.g., 400 N). As a result, a broad nip (fixing nip) N with respect to the sheet feeding direction V is formed between the heating belt 130 and the pressing belt 120.

Then, a driving force of a driving motor 163 controlled by the CPU 10 is transmitted to a driving gear G mounted to a shaft 131a of the driving roller 131, so that the driving roller 131 is rotationally driven and the heating belt 130 is circulated and rotated in the clockwise direction of an arrow in FIG. 4. In order to stably feed the sheet, drive (driving force) is transmitted between the heating belt 130 and the driving roller 131 with reliability. Also the pressing belt 120 in the pressing unit B side is circulated and rotated in the counterclockwise direction of an arrow by the rotation of the heating belt 130 with the frictional force with the heating belt 130 at the nip N. The heating belt 130 is heated by an IH heater 135 and is raised to a predetermined fixing temperature and thus is temperature-controlled.

In this state, the sheet S carrying an unfixed toner image t is introduced from an entrance side into the fixing device 100, and is guided by a guiding member (not shown) to enter the nip N, so that the sheet N is nipped and fed. As a result, the toner image t is thermocompression-fixed as a fixed image. The sheet S comes out of the nip N and discharged from the fixing device 100 in an exit side.

As described above, in this embodiment, the heating belt 130 and the pressing belt 120 form the nip N for heating the toner image t on the sheet (recording material), and at least one of these belts is an endless belt.

### (Belt Shift Control Mechanism)

In a rotational process of the heating belt 130 in the heating belt unit A, a phenomenon (belt shift movement) that the heating belt 130 shifts toward a front side or a rear side with respect to a widthwise direction perpendicular to the sheet feeding direction V generates. Further, in a rotational process of the pressing belt 120 in the pressing belt unit B, a phenomenon that also the pressing belt 120 shifts toward the front side or the rear side with respect to the widthwise direction perpendicular to the sheet feeding direction V generates. FIG. 7 shows a state in which the pressing belt 120 in the pressing belt unit B moves in its rotational process so as to shift toward the front side or the rear side with respect to a widthwise direction W perpendicular to the sheet feeding direction V.

In this embodiment, the belt shift movement is stabilized within a predetermined shift range (predetermined zone) by swing-type shift control. The swing-type shift control is a method in which when movement of a belt position from a widthwise central portion by a predetermined amount or more is detected, the tension roller is inclined (tilted) as a steering member in a direction opposite to a belt shift movement direction.

By repeating the swing-type shift control (belt shift movement control: meandering control), the belt periodically moves from one widthwise side (one direction with respect to the widthwise direction) to the other widthwise side (the other direction with respect to the widthwise direction), and therefore, the belt shift movement can be stably controlled. That is, the belt is constituted so as to be capable of reciprocating in the direction W perpendicular to the feeding direction V of the sheet S.

The heating belt unit A and the pressing belt unit B are provided with similar belt shift controls (belt steering mechanisms), and shift control of the heating belt 130 and shift control of the pressing belt 120 are similarly effected independently. Therefore, in the following, the belt shift control mechanism in the pressing belt unit B side and the shift control of the pressing belt 120 will be described as a representative, and the belt shift control mechanism in the heating belt unit A side and the shift control of the heating belt 130 will be omitted from description.

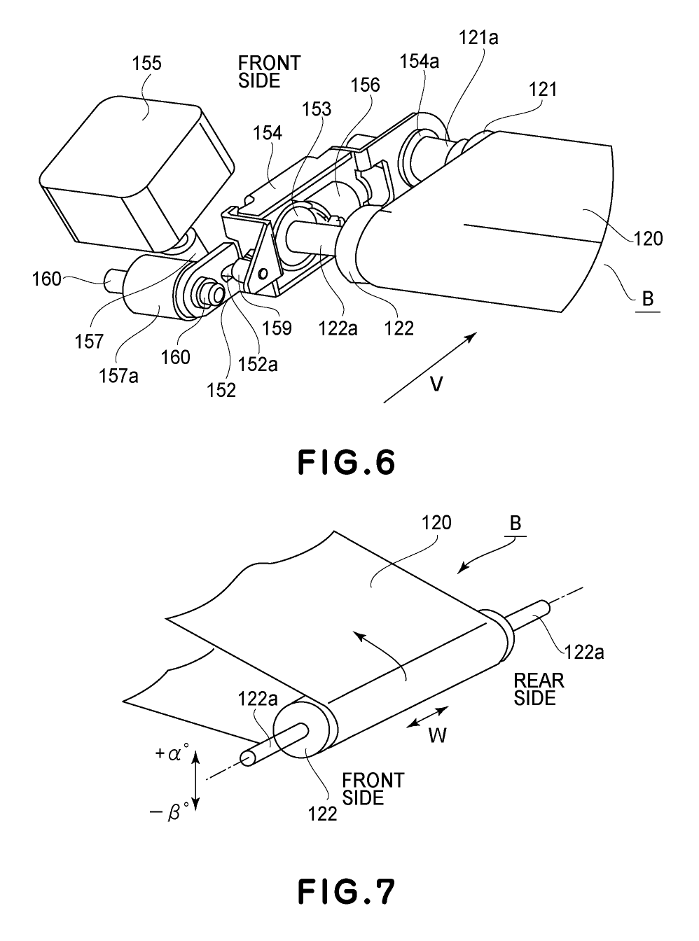

With reference to FIGS. 3 and 6, a supporting arm 154 is provided on a side plate of a casing 140 in the front side. The supporting arm 154 is supported by a shaft 121a of the pressing roller 121 in the front side via a bearing 154a and is rotatable about the shaft 121a as a center (supporting point), and extends toward the sheet entrance side. At a free end portion of the supporting arm 154, a pin 159 is provided. At a portion between the bearing 154a of the supporting arm 154 and the pin 159, a movable bearing 153 having a degree of freedom such that the bearing 153 is engaged and movable along an elongated hole with respect to a longitudinal direction is provided. A shaft 122a of the tension roller 122 in the front side is supported by the bearing 153. The bearing 153 is moved and urged in a direction in which tension is applied to the pressing belt 120 by a tension spring (urging member) 156. The tension of 20 kgf is applied to the pressing belt 120 by the tension spring 156.

On the side plate of the casing 140 in the front side, a shaft 160 is provided in the sheet entrance side. A worm wheel (helical gear) 157a is rotatably supported by the shaft 160. A fork plate (control arm) 152 including a U-shaped groove 153a is provided integrally with the worm wheel (helical gear) 157a. Further, the pin 159 of the supporting arm 154 is engaged with and supported by the groove 152a of the fork plate 152. On the side plate of the casing 140 in the front side, a stepping motor 155 is provided. A worm 157 fixed on a rotation shaft of the motor 155 is engaged with the worm wheel 157a.

The stepping motor 155 is rotationally driven normally or reversely, so that the fork plate 152 is rotated in an upper (upward) direction or a lower (downward) direction via the worm 157 and the worm wheel 157a. In interrelation with this rotation, the supporting arm 154 is rotated about the shaft 121a in the upper direction or the lower direction. With this rotation, the shaft 122a of the tension roller 122 in the front side is moved in the upper direction or the lower direction with the rear side shaft 122 as a supporting point. As a result, a degree of inclination of the tension roller 122 changes, so that belt shift correction is made.

That is, the tension roller 122 acts as a steering roller for adjusting a degree of meandering of the pressing belt 120 with respect to the widthwise direction (longitudinal direction) perpendicular to the movement direction of the pressing belt 120. Therefore, in the following, the tension roller 122 is referred to as the steering roller.

The steering roller 122, the fork plate (control arm) 152, the worm wheel 157a, the worm 157, the stepping motor 155, and the like which are described above constitute a belt reciprocating control means. That is, these members constitute a belt steering mechanism (displacing mechanism for displacing the steering roller 122 as a supporting member from a reference position to a first position in one longitudinal end (portion) side).

With reference to FIGS. 4 and 5, the casing 140 is provided with a sensor portion 150 for detecting a belt end portion position in a lower side of the pressing belt unit B is provided in the neighborhood of an end portion of the fixing device in the front side with respect to the widthwise direction of the pressing belt 120 perpendicular to the sheet feeding direction V. That is, the sensor portion 150 is a position detecting means (detector for detecting that the belt is out of a predetermined zone with respect to the widthwise direction of the belt) capable of detecting shift movement of the pressing belt 120 from one end portion side to the other end portion side with respect to the widthwise direction of the pressing belt 120.

The CPU 10 detects the end portion position of the pressing belt 120 by the sensor portion 150, and effects the belt shift correction by changing the degree of inclination of the steering roller 122 constituting the belt steering mechanism. As a result, control is effected so that reciprocating movement of the pressing belt 120 is made between the front side (one end portion side) and the rear side (the other end portion side) with respect to the widthwise direction of the pressing belt 120. That is, the belt steering mechanism is controlled so that the pressing belt 120 makes reciprocating movement in the predetermined zone with respect to the widthwise direction.

Incidentally, an operation of the belt shift control in the front side and a similar operation of the belt shift control in the rear side are performed independently. That is, the sensor portion 150 is provided at each of end portions of the pressing belt 120 with respect to the widthwise direction of the pressing belt 120, so that execution of operations in a first control mode and a second control mode, which are described later, in one end portion side and operations in the first control mode and the second control mode in the other end portion side are independently made.

The belt shift control is specifically effected by detecting the end portion position of the pressing belt 120 by the sensor portion 150, driving the stepping motor 155 plural times correspondingly thereto and by rotating the pressing belt 120 in a state in which the degree of the inclination of the steering roller 122. As a result, the shift control of the belt in an axial direction (widthwise direction) of the belt is realized. By changing alignment of the steering roller 122, a movement amount of the pressing belt 120 in the widthwise direction can be controlled.

The sensor portion 150 is a belt position detecting means for detecting a movement position of the pressing belt 120 with respect to the axial direction (widthwise direction) of the belt. The sensor portion 150 is constituted by first and second (two) sensors 150a and 150b, a sensor flag 150c which is a flag member, a sensor arm 150d and a sensor spring 150e for operating the sensor arm 150d so as to follow motion of the pressing belt 120. The sensor flag 150c rotates about a supporting point 150f is interrelation with the sensor arm 150d.

Further, the sensor arm 150d which is an arm member is urged and contacted to a front-side end surface (edge) 120a of the pressing belt 120 in one end portion side of the pressing belt 120 with a force of 3 gf. As a result, by a combination of ON/OFF signals of each of the first and second sensors 150a and 150b as a flag detecting means for optically detecting the sensor flag 150c which is the flag member rotating depending on the belt position with respect to the widthwise direction of the belt, the position detection of the pressing belt 120 with respect to the widthwise direction is made.

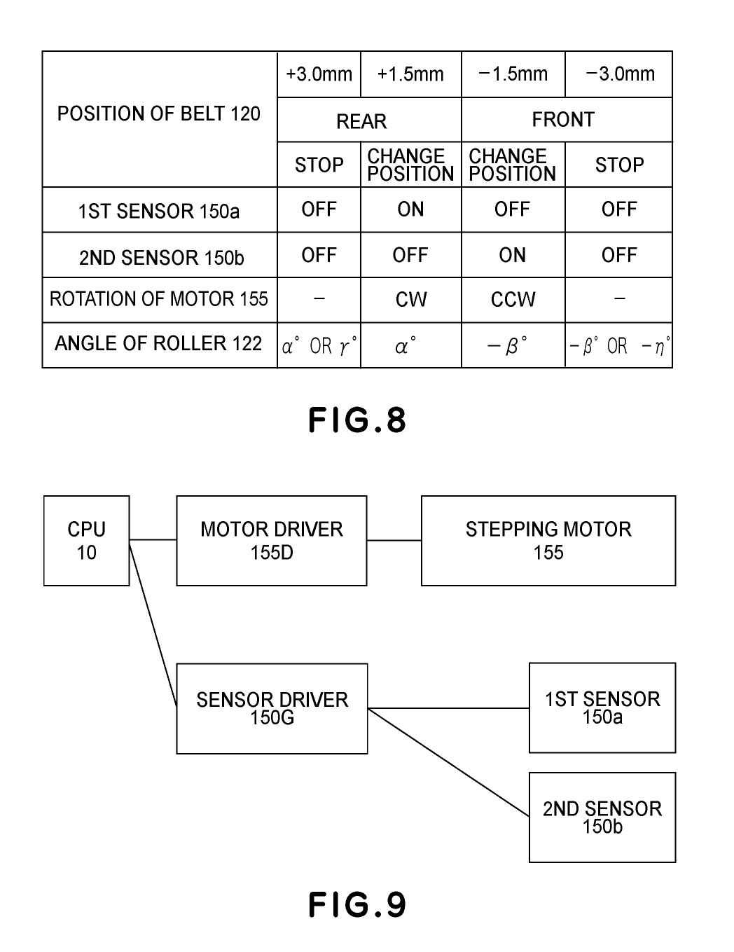

A relation between the combination of the ON/OFF signals of each of the first sensor 150a and the second sensor 150b and the end surface (edge) position of the pressing belt 120 at that time is shown in FIG. 8. Incidentally, when light travelling toward each of the first and second sensors 150a, 150b is blocked by the sensor flag 150c, the signal is an OFF signal, and when the light is transmitted to reach the each of the first and second sensors 150a, 150b, the signal is an ON signal.

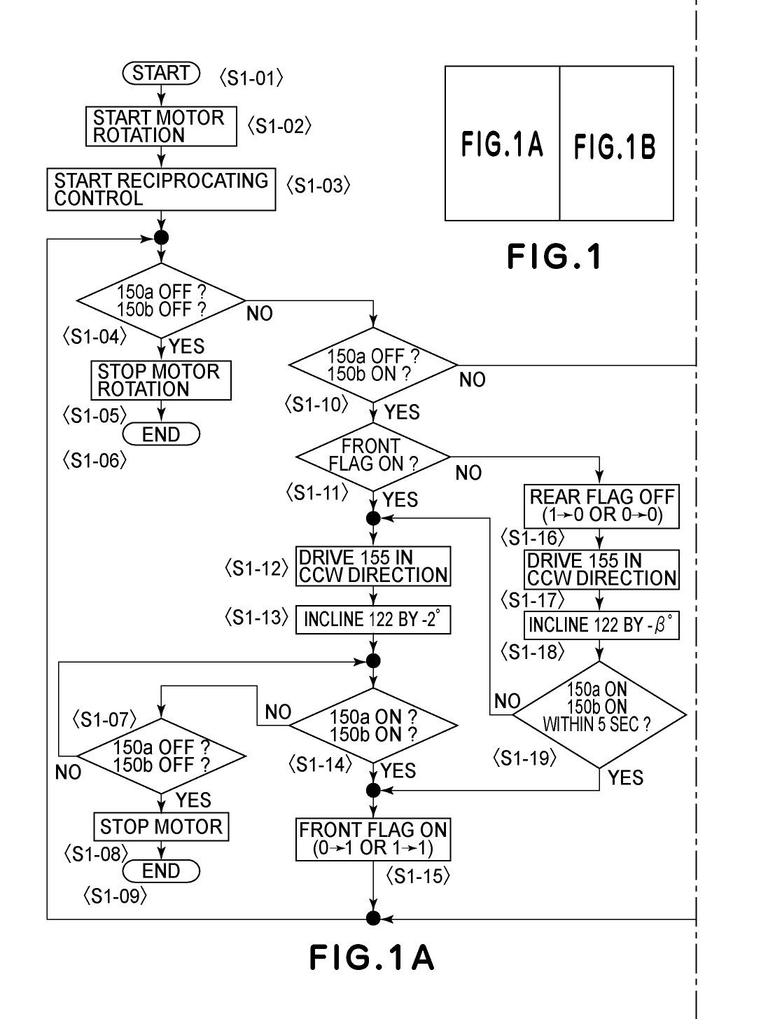

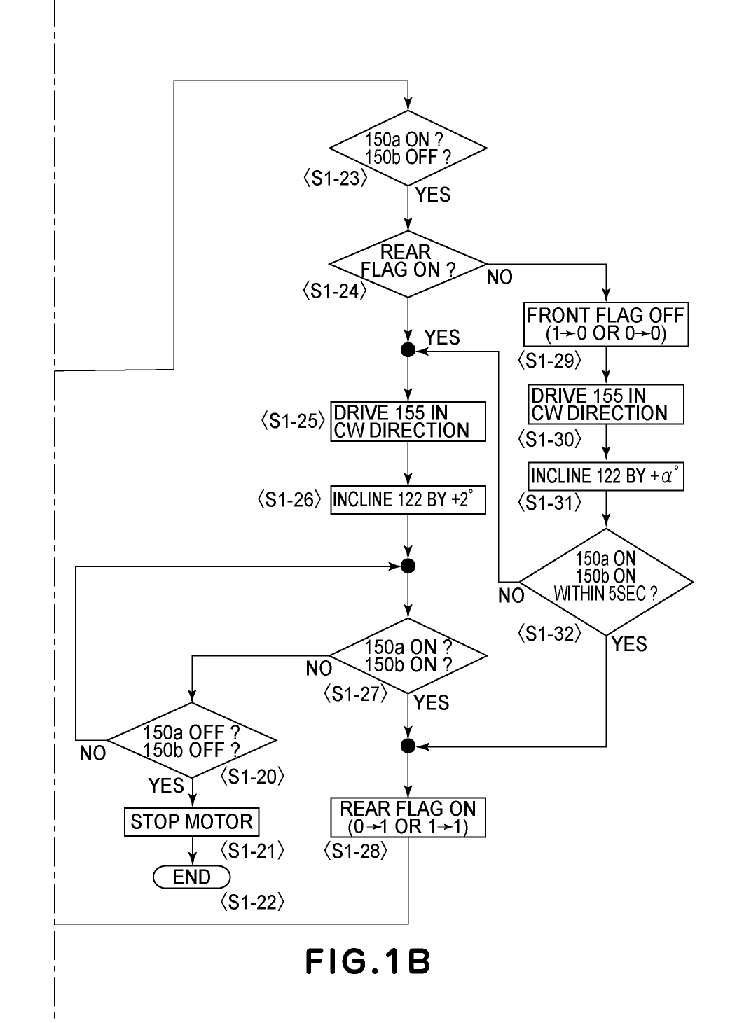

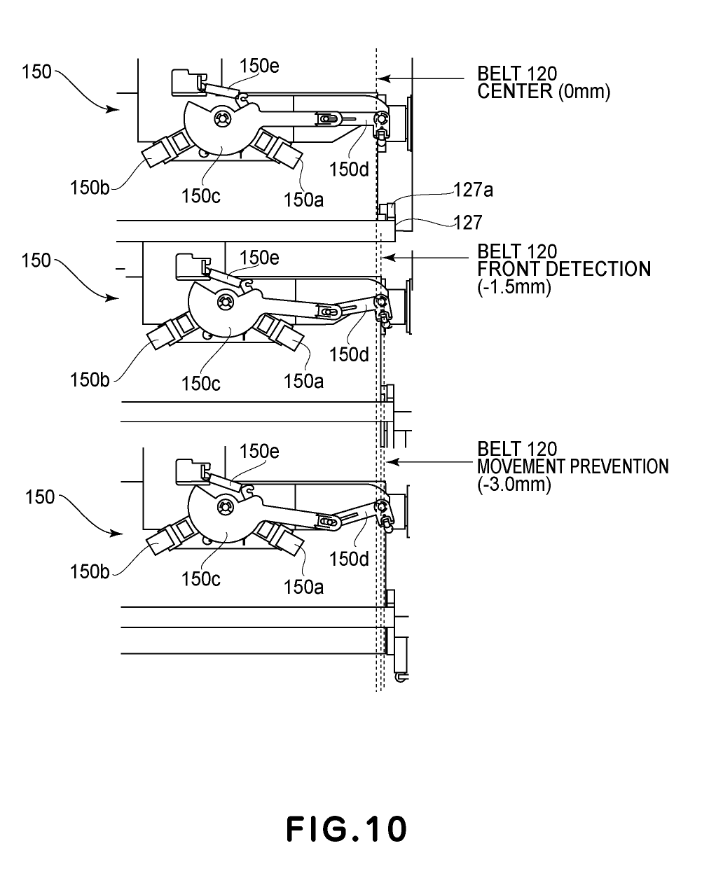

Further, a flowchart of the belt reciprocating control is shown in FIG. 1 (FIGS. 1A and 1B), and a block diagram of a control system for driving the steering roller 122 is shown in FIG. 9. Further, FIG. 7 shows an operation of the steering roller 122 for causing the pressing belt 120 to make the reciprocating movement. FIG. 10 shows a positional relation between a position of the pressing belt 120 with respect to a reciprocating direction and the first and second sensors 150a, 150b.

The pressing belt 120 reciprocates between a position where the first sensor 150a is ON and the second sensor 150b is OFF and a position where the first sensor 150a is OFF and the second sensor 150b is ON. The reciprocating control is effected so that the pressing belt 120 exists in a section therebetween (within a predetermined zone). A distance of the section is ±1.5 mm of a center position of the pressing belt 120 with respect to a rotational axis direction of the pressing belt 120.

As shown in FIG. 10, when the pressing belt 120 moves from the center position toward the front side, the sensor flag 150c acts through the sensor arm 150d contacting the pressing belt 120.

When the pressing belt 120 reaches a position of −1.5 mm in the front side, the sensor flag 150c is detected by the first sensor 150a and the signal of the first sensor 150a becomes the OFF signal, so that the steering roller 122 acts for moving the pressing belt 120 in the direction toward the rear side.

The movement direction of the pressing belt 120 is reversed and when the pressing belt 120 falls within a range of ±1.5 mm, the sensor flag 150c moves from the position where the sensor flag 150c is detected by the first sensor 150a, so that the signal of this sensor 150a becomes the ON signal (also the signal of the second sensor 150b is the ON signal).

On the other hand, when the pressing belt 120 reaches a position of +1.5 mm in the rear side, the sensor flag 150c is detected by the first sensor 150a and the signal of the second sensor 150b becomes the OFF signal, so that the steering roller 122 acts for moving the pressing belt 120 in the direction toward the front side.

The movement direction of the pressing belt 120 is reversed and when the pressing belt 120 falls within a range of ±1.5 mm, the sensor flag 150c moves from the position where the sensor flag 150c is detected by the second sensor 150b, so that the signal of this sensor 150b becomes the ON signal (also the signal of the first sensor 150a is the ON signal).

At a position of ±3.5 mm with respect to the reciprocating movement direction of the pressing belt 120, an arm wall surface 127a of the arm 127 exists (in both of the front side and the rear side). A position of ±3.0 of the pressing belt 120 is set as a movement regulating position in order to prevent breakage of the pressing belt 120 by contact with the arm surface 127a due to movement of the pressing belt 120 in the reciprocating direction.

That is, as shown in FIG. 10, when the pressing belt 120 reaches the position of −3.0 mm as the movement regulating position, the sensor flag 150c moves to a position where the sensor flag 150c is detected by both of the sensors 150a, 150b. As a result, the signals of the sensors 150a, 150b become the OFF signals. On the other hand, this is also true for the case where the pressing belt 120 reaches the position of +3.0 mm as the movement regulating position.

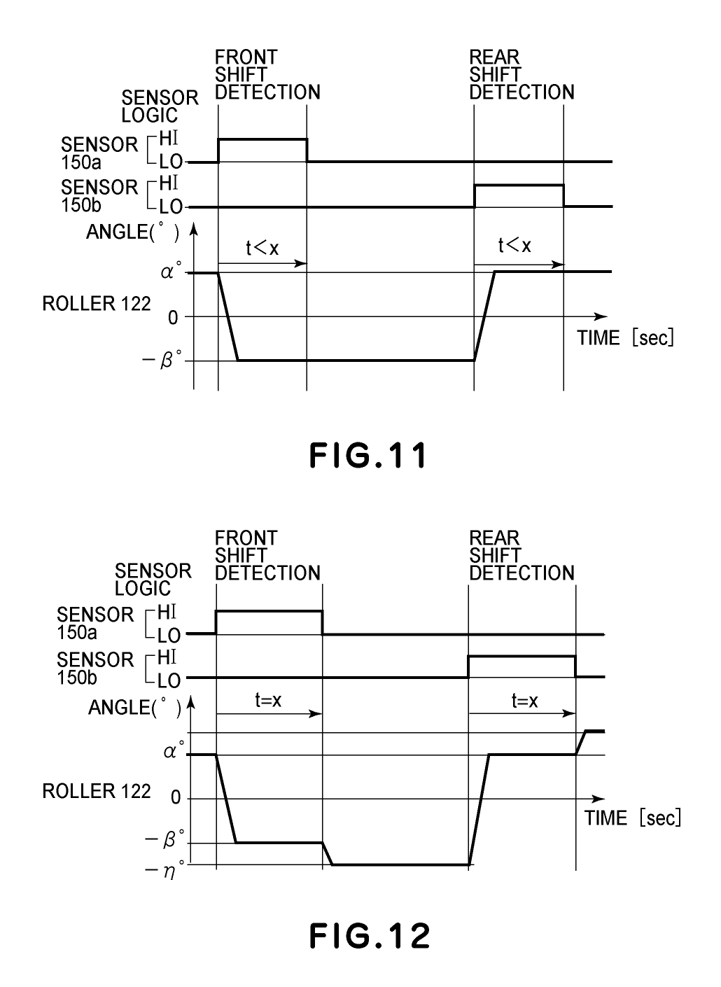

Next, with reference to FIG. 1 and FIGS. 11 and 12, the belt reciprocating control in this embodiment will be described. FIGS. 11 and 12 are timing charts of the signals of the first sensor 150a and the second sensor 150b and an operating angle of the steering roller 122.

The fixing device 100 is driven, and with start of rotation of the heating belt 130 and the pressing belt 120 by the driving motor 163, the belt reciprocating control is started (S-01, S-02, S-03).

When the pressing belt 120 shifts toward the end portion side with respect to the widthwise direction, the sensor portion 150 detects that the pressing belt 120 reached a reciprocating direction changing position (S-10 or S1-23). Then, the CPU 10 which is a control means executes an operation in the first control mode. The first control mode is a control mode in which the belt steering mechanism is controlled so that the pressing belt 120 is moved to the other end portion side with a first control amount against the shift movement of the pressing belt 120, detected by the sensor portion 150, toward one end portion side with respect to the widthwise direction.

Specifically, with the first control amount, the movement direction of the pressing belt 120 with respect to the widthwise direction is changed to an opposite direction through the steering roller 122. That is, through the motor driver 155D (FIG. 9), a predetermined driving pulse is outputted to the stepping motor 155 (S1-17 or S1-30). Then, as shown in FIG. 7, by moving the front-side end portion of the steering roller 122 upward and downward, the steering roller 122 is inclined relative to the driving roller 131 by +α° or −β° (S1-18 or S1-31).

The pressing belt 120 changes the reciprocating direction and starts movement. Then, through the first sensor 150a and the second sensor 150b, the belt position detecting portion 150 detects that the pressing belt 120 changes in reciprocating direction and passes (S1-19, S1-32).

Angles α and β of the steering roller 122 are set to provide an inclination angle at which the reciprocating direction is not changed for maintaining the reciprocating control of the pressing belt 120, and in this embodiment, initial values thereof are 2° and −2°, respectively. The angles α and β are variable values depending on a reciprocating time of the pressing belt 120 (i.e., in interrelation with a movement time).

In the case where the belt shift is detected, by a first means, with the inclination of the steering roller 122 by +α° or −β° and the rotation of the pressing belt 120, the shift of the pressing belt 120 in the end portion direction is decelerated and is accelerated in the opposite direction. That is, reversal of the belt reciprocating direction is made in this manner (operation of FIG. 11).

Incidentally, misalignment between members for stretching the pressing belt 120 generates due to a horizontal state of the image forming apparatus 1 and tolerances or the like of constituent parts of the fixing device 100, so that the reciprocating movement of the pressing belt 120 becomes non-uniform in some cases. For example, in the case where movement of the pressing belt 120 in the front side direction (−direction) is fastened the movement in the rear side direction (+direction) is slow, responsiveness when the movement direction of the pressing belt 120 is changed from the front side direction to the rear side direction lowers.

In such a case, reduction in moving speed of the pressing belt 120 from the rear side direction to the front side direction by decreasing an absolute value of the angle β is effective. As a result, it becomes possible to reduce a deceleration/acceleration time of the pressing belt 120 during change in reciprocating direction in the front side, so that responsiveness when the movement direction is changed from the front side direction to the rear side direction can be improved.

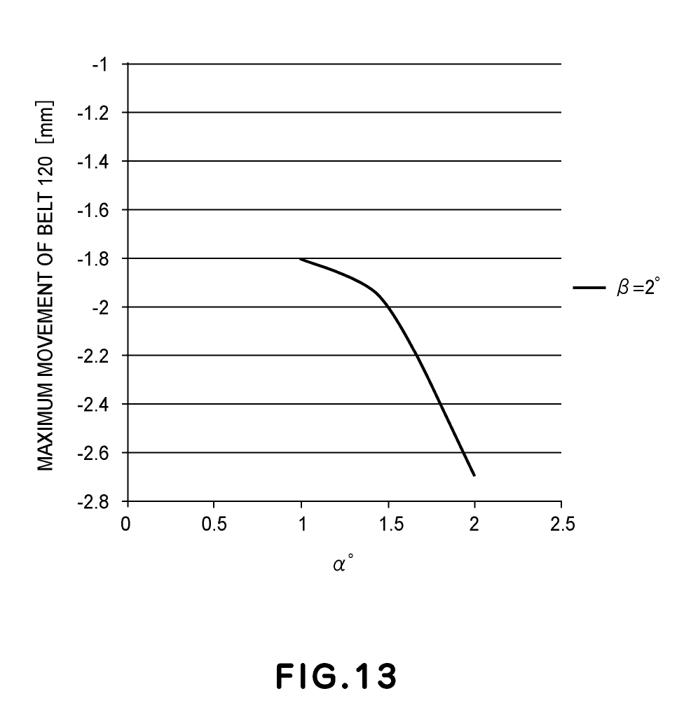

FIG. 13 shows an example of a relation between a maximum movement position where the pressing belt 120 moves when the pressing belt 120 moves to the front side with respect to the reciprocating direction, and α° and β°.

That is, in the case where β° is 2° and α° is 2°, the moving speed of the pressing belt from the rear side to the front side is fast. For that reason, when the angle of the steering roller 122 is changed from +2° to −2°, the deceleration takes time due to a factor such as slip with the steering roller 122, so that the pressing belt 120 moves to a position of about −2.7 mm in the front side.

On the other hand, in the case where β° is 1° and α° is 1°, the moving speed of the pressing belt from the rear side to the front side is slow. For that reason, when the angle of the steering roller 122 is changed from +1° to −2°, responsiveness of the reciprocating direction change of the pressing belt 120 to the angle change of the steering roller 122 is improved. As a result, the pressing belt 120 moves to a position of about −1.8 mm in the front side, so that reversal of the reciprocating operation can be completed.

That is, the inclination angle of the steering roller 122 is decreased, so that a reciprocating movement speed of the pressing belt 120 can be reduced. As a result, a degree of displacement of the sheet S, in the reciprocating movement direction of the pressing belt 120, nipped and fed at the nip N formed by the heating belt 130 and the pressing belt 120 can be reduced, so that stabilization of sheet behavior can be realized.

In this embodiment, control of changing the angles α, β is effected on the basis of a time from a state of S1-10 to a state of S1-23 of the pressing belt 120 in FIG. 1 and a time required for the reciprocating movement from the state of S1-23 to the state of S1-10.

Specifically, when the time of movement of the pressing belt 120 from the state of S1-10 to the state of S1-23 is less than 60 sec, the angle α changes by −0.1°. Further, when the time of movement of the pressing belt 120 from the state of S1-10 to the state of S1-23 is not less than 60 sec, the angle α increases by 0.1°. At this time, in order to prevent generation of abnormal reciprocating control and a change in reciprocating direction of the pressing belt 120, the change in angle α is limited so that the value of α is 1.0° to 2.0°.

Similarly, when the time of movement of the pressing belt 120 from the state of S1-23 to the state of S1-10 is less than 60 sec, the angle β decreases by 0.1°. Further, when the time of movement of the pressing belt 120 from the state of S1-23 to the state of S1-10 is not less than 60 sec, the angle β increases by 0.1°. At this time, also the change in angle β is limited so that the value of β is 1.0° to 2.0°.

The above-described changes in angles α, β are made for not only improving control stability of the pressing belt 120 by adjusting a reciprocating speed reducing amount of the pressing belt 120 but also reducing the influence of the movement of the pressing belt 120 in the reciprocating direction on the sheet behavior.

Incidentally, in the case where the reciprocating movement of the pressing belt 120 is liable to be subjected to disturbance, there arises a need to ensure a large inclination angle of the steering roller 122. In the fixing device 100 described in this embodiment, silicone oil application is made between the inner surface of the pressing belt 120 urged by the pressing pad 125 and the slidable sheet 128. For that reason, when the belt reciprocating direction is reversed, sliding generates between the pressing belt 120 and the roller stretching the pressing belt 120, so that responsiveness to reversal of the belt reciprocating direction lowers.

Further, an amount of the silicone oil supplied from the oil applying roller 126 to the inner surface of the pressing belt 120 decreases with an increase in contact time, and therefore a lubrication state changes between a brand-new state and a durable state. When the oil amount decreases, a degree of the sliding between the pressing belt 120 and the roller stretching the pressing belt 120 decreases, so that the responsiveness to the reversal of the belt reciprocating direction is improved.

That is, the moving speed of the pressing belt 120 in the reciprocating direction increases and the degree of the displacement of the sheet S in the belt reciprocating direction is increased, so that the behavior lowers. That is, the inclination angle of the steering roller 122 determined in view of a state in which the responsiveness to the reciprocating direction change of the belt with an ambient initial oil amount tends to gradually lower the sheet behavior due to durable use.

According to the belt reciprocating control type described in this embodiment, even in a system in which the above-described lubrication state changes, it becomes possible to not only improve the control stability of the pressing belt 120 but also reduce the degree of the influence of the belt reciprocating control on the sheet behavior.

Incidentally, due to the above-described change in amount of the oil supplied from the oil applying roller 126 and unexpected disturbance, the case where the reciprocating movement of the pressing belt 120 abruptly becomes non-uniform is assumed. That is, there is a possibility that the pressing belt 120 moves toward the widthwise end portion side and reaches the reciprocating direction changing position and the reciprocating direction change of the pressing belt 120 is not made in a state in which the steering roller 122 is inclined by +α° or −β°.

In the case where detection that the pressing belt 120 is not changed in reciprocating direction in a predetermined time of X sec is made (S1-19 or S1-32), the CPU 10 as the control means executes an operation in the second control mode. The second control mode is a control mode in which the belt steering mechanism is controlled in the following manner when the sensor portion 150 detects that the movement of the pressing belt 120 toward the other end portion side is not made. That is, the belt steering mechanism is controlled so that the pressing belt 120 is moved toward the other end portion side by changing the control amount to a second control amount larger than the first control amount. The CPU 10 further inclines the steering roller 122 with the second control amount.

Specifically, the CPU 10 includes a timer for counting a time in which the pressing belt 120 is in a state of being out of the predetermined zone from the displacement of the steering roller 122 to the first position by the steering mechanism (displacing mechanism). Further, when the time counted by the timer is a predetermined time, the CPU 10 controls the steering mechanism so that the pressing belt 120 is returned into the predetermined zone. That is, the CPU 10 controls the steering mechanism so that the steering roller 122 is displaced to a second position move spaced from a longitudinal one end portion side position of the steering roller 122 than the first position is.

That is, when detection times t of the first sensor 150a and the second sensor 150b reach a predetermined time X (sec), through the motor driver 155D (FIG. 9), a predetermined driving pulse is outputted to the stepping motor 155 (S1-12 or S1-25). Then, the steering roller 122 is inclined relative to the driving roller 131 by +γ° or −η° (S1-13 or S1-26).

γ° and η° are values determined in view of angles at which the reciprocating direction of the pressing belt 120 can be changed against variations of parts and disturbance and the like. In this embodiment, these values are calculated by the CPU 10 so that γ° is (2−α)° and γ° is (2−β)°.

X(sec) which is a time in which the degree of the change in belt reciprocating direction is a value determined by the moving speed in the belt reciprocating direction due to the rotational speed and the like of the pressing belt 120. It is suitable that a time in which the belt is not out of a belt traveling region and the belt end portion does not contact external parts is selected, and in this embodiment, X(sec) is 5 sec.

Similarly, after the reversal of the belt reciprocating direction is made by the first means with the inclination of the steering roller 122 by +α° or −β° and the rotation of the pressing belt 120, there is a possibility that the belt reciprocating movement direction is changed by abrupt disturbance.

The pressing belt 120 changes its reciprocating direction and starts movement thereof and when passing of the pressing belt 120 after the change in reciprocating direction is detected in the state S1-19 or the state S1-32, whether the pressing belt 120 passed through which one of the front side and the rear side is recorded by the CPU 10 (S1-15 or S1-28). As a method of recording, for example, a method in which the recording is made by setting the flag in the direction in which the pressing belt 120 passed and when detection that movement of the pressing belt 120 in the opposite direction is made (S1-16 or S1-29), the flag is reset is suitable.

After the pressing belt 120 moves toward the widthwise end portion side and detection that the pressing belt 120 reached the reciprocating direction changing position in the state of S-10 or the state of S1-23, the above-described direction in which the belt last passed is checked (S1-11 or S1-24).

In the case where the last belt passing direction (front-side direction) is the same as the detected belt movement direction (the case where the belt last passed through the front side in the state of S1-10 or the belt last passed through the rear side in the state of S1-23), the CPU 10 as the control means executes the operation in the second control mode.

Specifically, with the second control amount, the steering roller 122 is further inclined. That is, through the motor driver 155D (FIG. 9), a predetermined driving pulse is outputted to the stepping motor 155 (S1-12 or S1-25). Then, the steering roller 122 is inclined relative to the driving roller 131 by +γ° or −η° (S1-13 or S1-26). γ° and η° are determined similarly as in the above-described case where the reciprocating direction is not changed.

In the case where the thus-controlled pressing belt 120 is shifted toward the other end portion side while keeping the inclination angle at α° or β° or at γ° or η°, the steering roller 122 is subjected to the above-described operation similarly. That is, first, in the operation in the first control mode, the belt is reversed with the inclination angle of α° or β°, and when the belt reversing operation is not performed, the inclination angle is changed to +γ° or −η° in the operation in the second control mode.

As a result, a steering amount for the belt reciprocating control is reduced, so that not only stable belt reciprocating control and stabilization of recording material behavior but also a decrease in steering amount are realized and thus it becomes possible to realize a decrease in a degree of inconvenience of the belt reciprocating control caused by unexpected disturbance.

Therefore, an object to be controlled is not limited to the angle, but is also applied to an angle changing means such as an input pulse into the stepping motor 155 for changing the angles α°, β° by operating the steering roller 122, and thus is not limited to the contents described in this embodiment.

Further, the reciprocating direction change of the pressing belt 120 is discriminated using a detection time by the detecting means 150, so that the change in reciprocating movement behavior of the pressing belt 120 can be detected by a minimum detecting means. That is, an end portion detecting region (region from −1.5 mm to −3.0 mm in the front side) of the pressing belt 120 are monitored using a plurality of detecting means. As a result, in a type in which the change in reciprocating behavior of the pressing belt 120 is detected by the movement amount, the number of detecting means can be reduced, so that it becomes possible to reduce a cost and suppress an upsizing of the image heating apparatus.

Incidentally, in a state in which the reciprocating control is disabled, when the end (edge) surface of the pressing belt 120 reaches a position of ±3 mm from the center position, both of the first sensor 150a and the second sensor 150b are turned off (S1-04, S1-07, S1-20). At this time, the CPU 10 of the image forming apparatus discriminates that abnormality generates, and stops an rotation operation of the belt (S1-05, S1-08, S1-21) and stops the image heating apparatus (S1-06, S1-09, S1-22).

An execution relationship between the above-described operations in the first control mode and the second control mode are summarized as follows.

The tension roller (steering roller) 122 which is at least one of belt stretching means is inclined with a first inclination angle during execution of the operation in the first control mode. The tension roller 122 is inclined with a second inclination angle not less than the first inclination angle during the operation in the second control mode.

The CPU 10 at the control means executes the operation in the first control mode when the shift movement of the pressing belt 120 is detected by the sensor portion 150. Further, the CPU 10 executes the operation in the second control mode when the pressing belt 120 moving toward the other end portion side does not pass in a predetermined time.

The CPU 10 executes the operation in the first control mode when the shift movement of the pressing belt 120 is detected by the sensor portion 150. Further, after the passing of the pressing belt 120 moving toward the other end portion side is detected by the sensor portion 150, when the shift of the pressing belt 120 in the same direction toward the end portion side is detected again, the CPU 10 executes the operation in the second control mode.

The CPU 10 sets the first inclination angle in interrelation with a movement time of the pressing belt 120 from one end portion side toward the other end portion side.

The sensor portion 150 is provided at each of the end portions with respect to the widthwise direction of the pressing belt 120, and the execution of the operations in the first and second control modes in one end portion side and the execution of the operations in the first and second control modes in the other end portion side are made independently.

Although the description of the belt shift control mechanism in the heating belt unit A side and the shift control of the heating belt 130 will be omitted, these are similar to the above-described cases of the belt shift control mechanism in the pressing belt unit B side and the belt shift control. In FIGS. 3 and 4, a portion 150A corresponds to the sensor portion 150 in the pressing belt unit B side.

Further, members 154A, 153A, 156A and 160A correspond to the supporting arm 154, the bearing 153, the tension spring 156 and the shaft 160, respectively, in the pressing belt unit B side. Further, members 152A, 157A and 155A correspond to the fork plate 152, the worm 157 and the stepping motor 155, respectively, in the pressing belt unit B side.

According to the fixing device in this embodiment, by decreasing the steering amount for the belt reciprocating control, it is possible to realize stable belt reciprocating control and stabilization of sheet behavior.

### Modified Embodiments

(1) As described above, a preferred embodiment of the present invention was described, but the present invention is not limited thereto. Various modifications can be made within an equivalent range. For example, the present invention is applied to a constitution in which a belt-shaped member in the fixing device is subjected to the reciprocating control with a substantially predetermined range and is particularly applied to a constitution in which after the reciprocating direction is changed, the reciprocating movement speed can be reduced.

(2) Further, in the above-described embodiment, the pressing belt 120 was described, but the present invention is also applicable to the heating belt 130. That is, the present invention is applicable to the case where at least one of a first rotatable member and a second rotatable member which constitute the nip N includes the endless belt.

(3) In the above-described embodiment, as the image heating apparatus, the fixing device for heating and fixing the unfixed toner image t formed on the sheet (recording material) was described as an example, but the present invention is not limited thereto. The present invention is also applicable to an apparatus for increasing a gloss (glossiness) of an image by reheating a toner image fixed or temporarily fixed on 39-40 the sheet S.

(4) The image forming apparatus is not limited to the image forming apparatus for forming the full-color image as in the above-described embodiment, but may also be an image forming apparatus for forming a monochromatic image. Further, the image forming apparatus can be realized, in various uses, as apparatuses, such as a copying machine, a facsimile machine, a multi-function machine having a plurality of functions of these machines by adding thereto necessary devices, equipment and casing structure.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2015-234634 filed on Dec. 1, 2015, which is hereby incorporated by reference herein in its entirety.

What is claimed is:

1. An image heating apparatus comprising:
a pair of rotatable members at least one of which is an endless belt and configured to form a nip for heating a toner image on a recording material;
a roller configured to rotatably support said endless belt;
a detector configured to detect that said endless belt is out of a predetermined zone with respect to a widthwise direction thereof;
a displacing mechanism configured to displace one longitudinal end of said roller from a first position to a second position depending on an output of said detector so as to return said endless belt to the predetermined zone; and
a timer configured to count a time in which said endless belt is out of the predetermined zone from displacement of said roller to the second position by said displacing mechanism,
wherein when the time counted by said timer is a predetermined time, said displacing mechanism displaces the one longitudinal end of said roller to a third position remoter from the first position than the second position so as to return said endless belt to the predetermined zone.
